(19) United States
(12) Patent Application Publication
(10) Pub. No.: US 2023/0123952 A1
(43) Pub. Date: Apr. 20, 2023

(54) LUMINOUS PICTURE

(71) Applicant: Benignus Okeke, Zülpich (DE)

(72) Inventor: Benignus Okeke, Zülpich (DE)

(21) Appl. No.: 17/911,994

(22) PCT Filed: Mar. 16, 2021
(86) PCT No.: PCT/EP2021/056607

§ 371 Date: Sep. 15, 2022

(30) Foreign Application Priority Data
Mar. 17, 2020 (DE) 20 2020 101 456.0

(51) Int. Cl. B44F 1/08; G09F 13/20

(52) U.S. Cl. CPC B44F 1/08; G09F 13/20

(57) ABSTRACT

The present invention relates to a luminous picture comprising first, differently contoured, coloured portions (11, 12, 13, 14) in different colours and second portions (17, 18) which differ from the first portions and which are covered with photoluminescent luminous paint that shines in the dark, wherein the first and the second portions are situated on a substrate (10), wherein, according to the invention, each contour of the first portions (11, 12, 13, 14) has been traced using a narrow line-shaped edge (16) made of photoluminescent luminous paint (15).

The present invention relates to a luminous picture comprising first, differently contoured portions which are coloured in different colours and second portions which differ from the first portions and are covered with photoluminescent luminous paint which glows in the dark, the first and the second portions being situated on a substrate. The present invention furthermore relates to a method for producing a luminous picture of the aforementioned type.

DE 1 727 147 discloses a picture or carving which is painted or reproduced by printing and glows in the dark as a result of the use of luminous paints, the picture being painted or printed using normal, commercially available paints, and fields or contours of radioactive luminous paint are added only in the highlights of the picture, said fields or contours being the same shape as the highlights, in such a manner that the free base paints are illuminated and become visible in the dark.

Luminous powders which are activated by sunlight (UV radiation) during the day and then glow for a relatively long time during the night owing to photoluminescence are known from the prior art. Such luminous powders on the basis of strontium aluminate, which is optionally doped with rare earths such as europium or dysprosium, are commercially available. After activation, they can glow for several hours in different colours (wavelengths).

The object of the present invention consists in providing a luminous picture which has the features of the type mentioned at the outset and has flexible possibilities for variable design.

This object is achieved by a luminous picture of the type mentioned at the outset having the characterising features of the main claim.

According to the invention, the contours of the first portions are each traced by a narrow linear border of photoluminescent luminous paint. As a result of this measure, the contours of figures or other structures in the picture are highlighted, and the contoured areas are illuminated by the glowing border and thus optically emphasised in the dark.

The application of the luminous paint in the region of the linear border can be carried out for example by means of a paintbrush, and the contours can be traced multiple times.

According to a preferred development of the invention, the first portions are formed from coloured foam rubber. Foam rubber is a material which is particularly well suited to this type of luminous picture, since it can be worked easily with a blade, and therefore the contours of the coloured portions can conveniently be produced manually using a blade or similar sharp tool. Moreover, the foam rubber can be either obtained already dyed in different colours or optionally dyed in the desired colour by the user creating the picture. The portions of foam rubber cut to shape in correspondence with the desired contours can then be applied to the substrate.

According to a preferred variant of the present invention, the paint applied to the first portions can contain glitter particles, for example. As a result, an additional effect is produced, which makes these coloured areas stand out even more.

In this exemplary variant of the present invention, the first portions of foam rubber are preferably cut and glued to a substrate on preferably corrugated cardboard, wood, cardboard, paper, plastic or another suitable flat material.

According to a preferred alternative variant of the invention, the first portions and optionally also the second portions can also consist of an epoxy resin or acrylic resin and be milled two-dimensionally out of this material. In this case, for example, the procedure can be such that an epoxy resin or acrylic resin is poured into a flat mould and cured, and the resin is coloured with a suitable paint (for example acrylic paint) before solidification in order to produce the colouring. In this case too, glitter particles can be added to the resin compound, or a luminous paint can be stirred into the resin compound in order to produce the second glowing portions, for example. The cured coloured resin compound can then be worked mechanically, either manually using an appropriate sharp tool or else using a machine tool. In the latter case, a CAD milling machine can be used, for example, and the contours intended for the portions can be milled out of the coloured resin compound in a shape specified in advance by means of software.

According to a preferred development of the invention, free regions of the substrate can be provided between the first portions and are then provided with photoluminescent luminous paint and form second portions. In this way, for example, second portions can be provided, which are partially or fully surrounded by the first portions and thus lie in the lower plane of the substrate, since the material used for the first portions applies something. As a result, coloured regions which glow in the dark are obtained, which are surrounded by non-glowing, differently coloured regions, the former emitting onto the latter and lighting them up.

According to a preferred development of the invention, the foam rubber, epoxy resin or acrylic resin is applied to the substrate in layers having a material thickness of 1 mm to 4 mm, preferably of 2 mm to 3 mm. In the coloured regions of foam rubber or resin, the luminous picture is elevated but is built up only a little relative to the substrate, so that the luminous picture overall remains flat.

The present invention furthermore relates to a method for producing a luminous picture, comprising the steps mentioned below:
coloured contoured regions, which each have the same or different colours, are cut, punched or separated in another suitable way out of a material consisting of foam rubber, epoxy resin or acrylic resin;
these coloured contoured regions are glued to a substrate, in particular consisting of card, paper or the like, so that they are elevated relative to the substrate;
the coloured regions form first portions of the luminous picture and are glued such that second portions remain between or adjacent to these first portions, said second portions consisting of the material of the substrate and not being elevated;
the contours of the coloured regions are fully or partially traced by means of a paintbrush or pen with a luminous paint which glows in the dark, so that frames around the coloured regions result from the luminous paint;
the second portions are covered with a luminous paint.

The features mentioned in the dependent claims relate to preferred developments of the solution according to the invention. Further advantages of the invention can be drawn from the detailed description below.

The present invention is described in more detail below using an exemplary embodiment with reference to the attached drawing.

### IN THE DRAWING

FIG. 1 shows a schematically simplified illustration of an exemplary luminous picture according to the present invention.

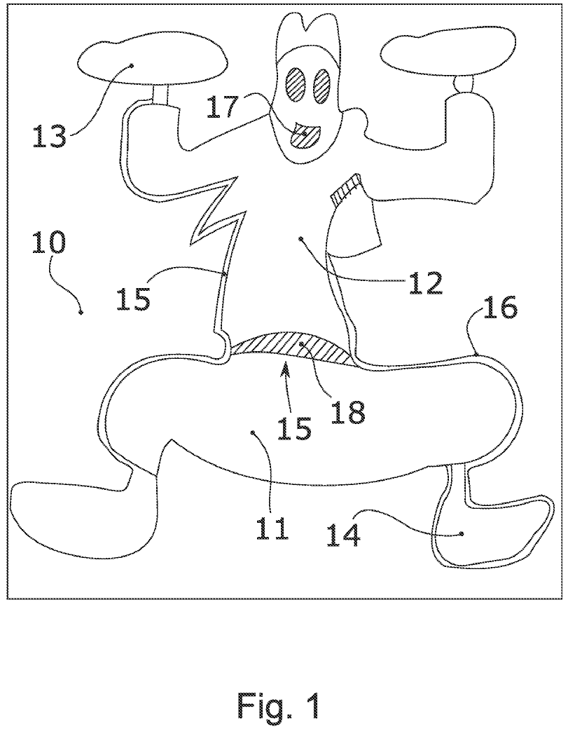

In the following, reference is made first to FIG. 1, and the basic construction of a luminous picture according to the present invention is explained using this schematically simplified illustration. FIG. 1 is an arbitrary illustration of a fantasy character with which the present invention is explained. The principle of the present invention can of course also be transferred to luminous pictures with any other representational or abstract illustrations. The luminous picture comprises different coloured regions, which consist for example of foam rubber or an epoxy resin or acrylic resin and are glued to a substrate 10 for example consisting of card. These regions 11, 12, 13, 14 can consist of different colours and thus produce a coloured picture. They can each be cut out in the desired shape using a tool such as a blade and then glued so that the desired picture results overall.

The contours of these coloured regions 11, 12, 13, 14 can then be traced fully or partially, for example by means of a paintbrush, with a luminous paint 15 which glows in the dark, so that virtual frames 16 around the coloured regions 11, 12, 13, 14 result. The coloured, non-glowing regions are thus highlighted and also partially illuminated in the dark.

In the present application, the coloured regions 11, 12, 13, 14 are also referred to as first portions of the luminous picture. These first portions 11, 12, 13, 14 are elevated relative to the substrate 10, since they consist of foam rubber or resin compound and are glued to said substrate. According to the invention, further portions 17, 18, which are referred to herein as second portions, are not elevated and thus lie in the plane of the substrate 10, can also be situated within the regions of these first portions 11, 12, 13, 14. These second portions 17, 18, which can be completely surrounded by the first portions, are likewise covered with a luminous paint 15. As a result, these second portions 17, 18 glow in the dark and are particularly highlighted relative to the other coloured portions 11, 12, 13, 14, which produces an intended aesthetic effect and a contrast.

### LIST OF REFERENCE SIGNS

10 Substrate
11 Coloured region, first portion
12 Coloured region, first portion
13 Coloured region, first portion
14 Coloured region, first portion
15 Luminous paint
16 Frames, borders
17 Second portion
18 Second portion

What is claimed is:

1. A luminous picture comprising:
a substrate;
a plurality of differently contoured first portions which are coloured in different colours; and
a plurality of second portions which differ from the first portions and are covered with at least one photoluminescent luminous paint which glows in the dark;
the first and the second portions being situated on the substrate; and
the contours of the first portions being each traced by a narrow linear border of photoluminescent luminous paint.

2. The luminous picture according to claim 1, wherein the first portions are formed from coloured foam rubber.

3. The luminous picture according to claim 2, wherein paint containing glitter particles is applied to the first portions.

4. The luminous picture according to claim 1, wherein the first portions are cut out of foam rubber and glued to the substrate.

5. The luminous picture according to claim 1, wherein at least one of the first portions and the second portions is milled two-dimensionally out of an epoxy resin or acrylic resin.

6. The luminous picture according to claim 5, wherein the epoxy resin or acrylic resin of the second portionscontains photoluminescent luminous paint and/or glitter particles.

7. The luminous picture according to claim 1, wherein the second portions are regions of the substrate between the first portions to which photoluminescent luminous paint has been applied.

8. The luminous picture according to claim 1, wherein at least one of foam rubber, epoxy resin and acrylic resin is applied to the substratein layers having a material thickness of 1 mm to 4 mm.

9. A method for producing a luminous picture, the method comprising:
forming contoured regions , having the same or different colours, out of a material comprising at least one of foam rubber, epoxy resin and acrylic resin;
adhering the coloured contoured regions to a substrate, the contoured regions thereby forming first portions that are elevated relative to the substrate second portions being thereby formed between or adjacent to the first portions, said second portions comprising the material of the substrate and not being elevated;
fully or partially tracing contours of the coloured regions with a first luminous paint which glows in the dark, so that framesaround the coloured regions result from the luminous paint; and
covering the second portions with a second luminous paint.

10. The luminous picture according to claim 1, wherein the substrate comprises at least one of corrugated cardboard, wood, cardboard, paper, and plastic.

11. The luminous picture according to claim 8, wherein the at least one of foam rubber, epoxy resin, and acrylic resin is applied to the substrate in layers having a material thickness of 2 mm to 3 mm.
